(19) United States
(12) Patent Application Publication
(10) Pub. No.: US 2015/0290782 A1
(43) Pub. Date: Oct. 15, 2015

(54) Fastener Driving Tool with Electric Heating Unit

(71) Applicant: Hong Ann Tool Industries Co., Ltd., Taichung City (TW)

(72) Inventor: Cheng-Wei Su, Taichung City (TW)

(21) Appl. No.: 14/644,238

(22) Filed: Mar. 11, 2015

(30) Foreign Application Priority Data
Apr. 11, 2014 (TW) 103113367

(51) Int. Cl. B25B 23/00; B25B 13/06

(52) U.S. Cl. CPC B25B 23/00; B25B 13/06

(57) ABSTRACT

A fastener driving tool includes a handle, a driving unit, and a heating unit. The handle includes an assembling end, a gripping end, and a receiving slot arranged in the handle. The driving unit includes a connecting end connected to the assembling end, and a driving end. The heating unit is received in the receiving slot of the handle and includes a circuit board and a heater. The circuit board is electrically connected with the heater. The heater connects and contacts with the driving unit. The heater is adapted for producing and conducting heat to the driving unit to melt the threadlocker.

### BACKGROUND

The present invention relates to a fastener driving tool and, more particularly, to a fastener driving tool having an electric heating unit for the removal of the fastener held by the threadlocker.

Threadlocker is an adhesive applied to the threads of fasteners such as screws and bolts to prevent loosening, leakage, and corrosion. The threadlocker may be applied before or after assembly. The application of heat is needed to remove a fastener that is held by the threadlocker, which can't be removed with a common fastener driving tool.

However, a user must first prepare a heating tool such as a heat gun and a propane torch to heat the fastener held by the threadlocker, and then use the common fastener driving tool to rotate the fastener.

Thus, a need exists for novel fastener driving tools to mitigate and/or obviate the above disadvantages.

### BRIEF SUMMARY

A fastener driving tool according to the present invention includes a handle, a driving unit, and a heating unit. The handle includes an assembling end and a gripping end opposite to the assembling end. A receiving slot is arranged in the handle and disposed between the assembling end and the gripping end. The driving unit is adapted for driving a fastener and includes a connecting end and a driving end opposite to the connecting end. The connecting end of the driving unit is connected to the assembling end of the handle. The driving end of the driving unit extends opposite to the gripping end of the handle. The heating unit is received in the receiving slot of the handle. The heating unit includes a circuit board and a heater. The circuit board is electrically connected with the heater. The heater connects and contacts with the driving unit. The heater is adapted for producing and conducting heat to the driving unit.

The handle includes an assembling slot arranged at the assembling end, with the assembling slot disposed at a side of the receiving slot adjacent to the assembling end. The assembling slot is connected and in communication with the receiving slot. The driving unit includes a rod member provided with an assembling portion at an end thereof adjacent to the connecting end. The assembling portion is engaged into the assembling slot. The heater connects and contacts with the assembling portion of the rod member.

In an example, the driving unit includes a connecting member and a driving head. The connecting member is connected to an end of the rod member opposite to the handle. The driving head is rorarably connected to an end of the connecting member opposite to the rod member.

The end of the connecting member opposite to the rod member is provided with a spherical head portion. The head portion has a hexagonal cross-section along the radial direction of the driving unit. The driving head includes a hexagonal receiving hole formed adjacent to the connecting member. The receiving hole of the driving head is rorarably engaged with the head portion of the connecting member.

The driving head includes a hexagonal driving hole formed at an end thereof opposite to the connecting member.

In another example, the rod member of the driving unit includes a hexagonal driving hole formed at an end thereof opposite to the assembling portion.

The handle includes a storage slot located in the gripping end. The storage slot is connected and in communication with the receiving slot and adapted to receive batteries to provide electricity to the heating unit.

The assembling slot has a non-circular cross-section along a radial direction of the handle, and the assembling portion has a non-circular cross-section along a radial direction of the driving unit.

The circuit board includes a switch for controlling electricity to the heater of the heating unit, and the switch is exposed out of an outer surface of the handle.

The connecting member is threadly connected to the end of the rod member opposite to the handle.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a fastener driving tool of a first embodiment according to the present invention.

FIG. 2 is an exploded perspective view of the fastener driving tool of FIG. 1.

FIG. 3 is a cross sectional view of the fastener driving tool of FIG. 1.

FIG. 4 is a perspective view of the fastener driving tool of FIG. 1, illustrating a driving unit to be heated and preparing to rotate a fastener.

FIG. 5 is a cross sectional view of the fastener driving tool of FIG. 1, illustrating the driving unit connecting to the fastener.

FIG. 6 is a cross sectional view of a fastener driving tool of a second embodiment according to the present invention, illustrating a driving unit connecting to a fastener.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “outer”, “top”, “bottom”, “side”, “end”, “portion”, “section”, “longitudinal”, “radial”, “height”, and similar terms are used herein, it should be understood that these terms have reference only to the structure shown in the drawings as it would appear to a person viewing the drawings and are utilized only to facilitate describing the illustrative embodiments.

### DETAILED DESCRIPTION

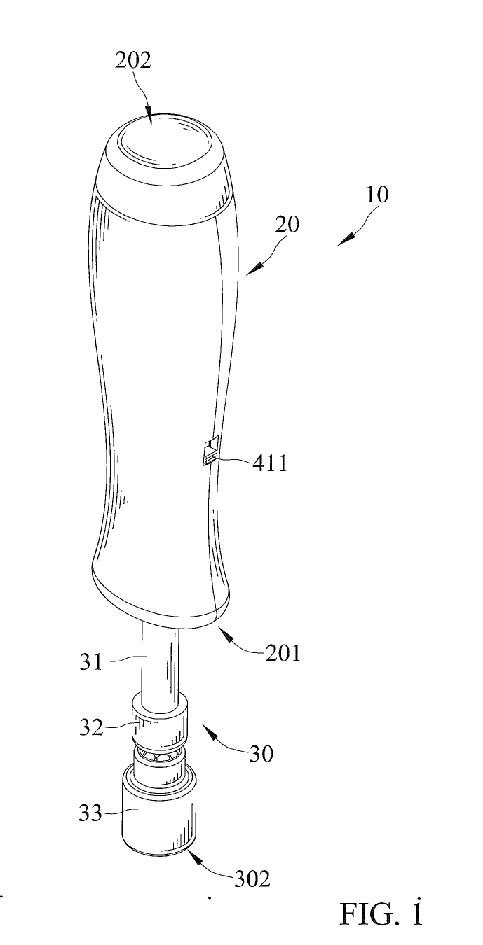

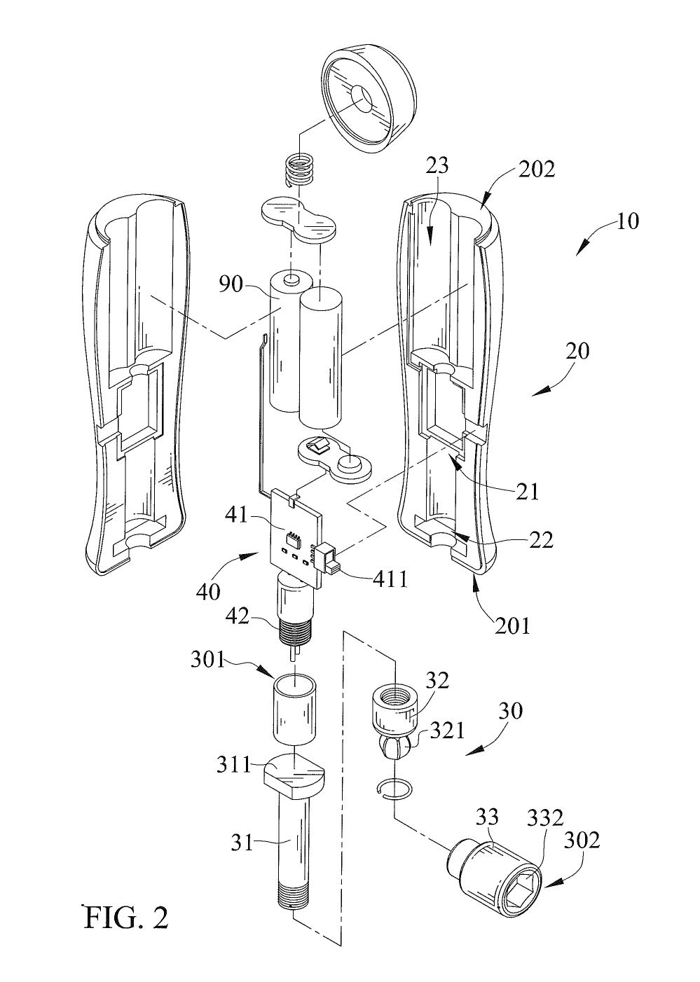

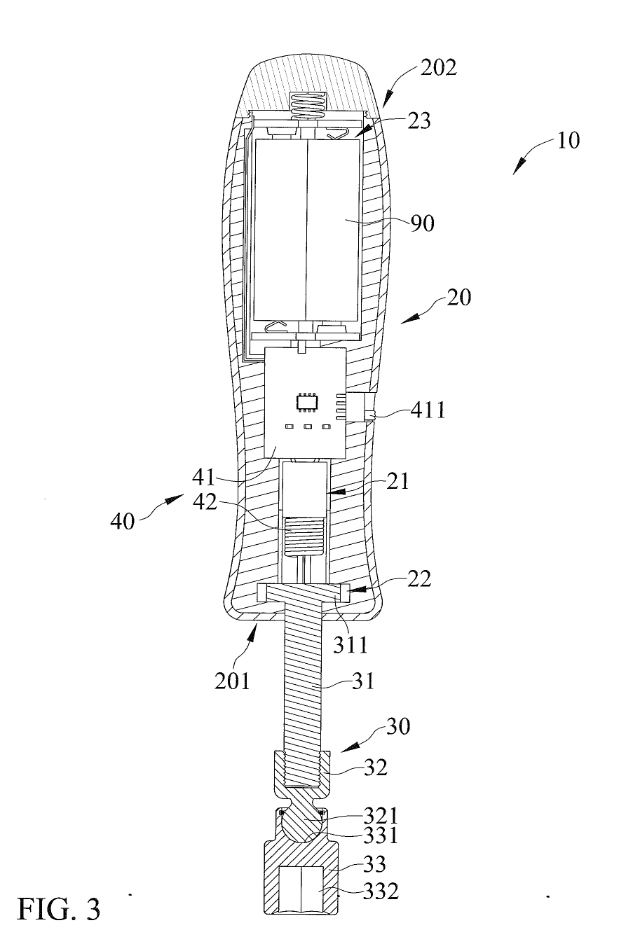

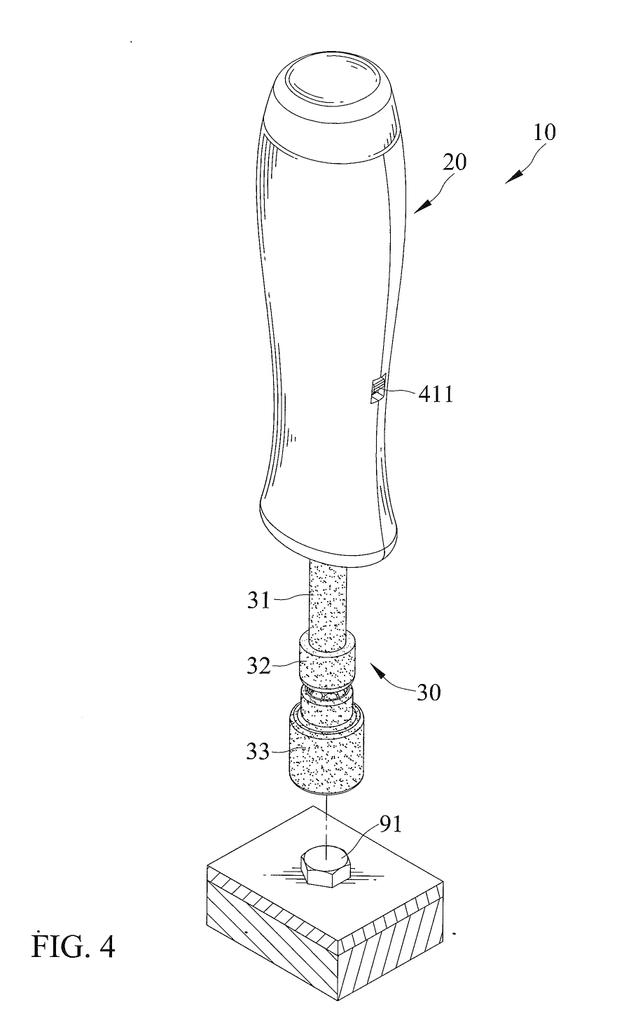

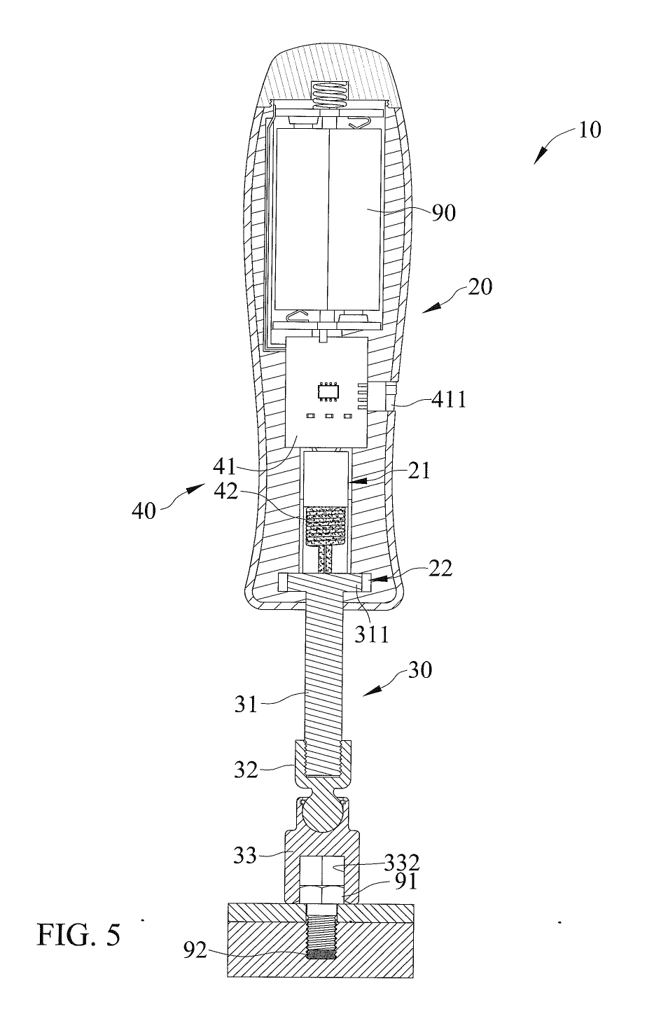

FIGS. 1-5 show a fastener driving tool 10 of a first embodiment according to the present invention includes a handle 20, a driving unit 30, and a heating unit 40.

The handle 20 includes an assembling end 201 and a gripping end 202 opposite to the assembling end 201. A receiving slot 21 is arranged in the handle 20 and disposed between the assembling end 201 and the gripping end 202. The handle 20 includes an assembling slot 22 and a storage slot 23. The assembling slot 22 is located at the assembling end 201 and disposed at a side of the receiving slot 21 adjacent to the assembling end 201. The assembling slot 22 is connected and in communication with the receiving slot 21. In this embodiment, the assembling slot 22 has a non-circular cross-section along a radial direction of the handle 20. The storage slot 23 is located in the gripping end 202 and also connected and in communication with the receiving slot 21. The storage slot 23 is adapted to receive batteries 90 to provide electricity to the heating unit 40.

The driving unit 30 is adapted for driving a fastener 91 such as a screw and a nut. The driving unit 30 includes a connecting end 301 and a driving end 302 opposite to the connecting end 301. The connecting end 301 of the driving unit 30 is connected to the assembling end 201 of the handle 20. The driving end 302 of the driving unit 30 extends opposite to the gripping end 202 of the handle 20. The driving unit—30 includes a rod member—31, a connecting member 32, and a driving head 33. The rod member 31 is provided with an assembling portion 311 at an end thereof adjacent to the connecting end 301. The assembling portion 311 is engaged into the assembling slot 22 of the handle 20. In this embodiment, the assembling portion 311 has a non-circular cross-section along a radial direction of the driving unit 30. The connecting member 32 is connected to an end of the rod member 31 opposite to the handle 20. In this embodiment, the connecting member 32 is threadly connected to the end of the rod member 31. The driving head 33 is rorarably connected to an end of the connecting member 32 opposite to the rod member 31. The end of the connecting member 32 opposite to the rod member 31 is provided with a spherical head portion 321, which has a hexagonal cross-section along the radial direction of the driving unit 30. The driving head 33 includes a hexagonal receiving hole 331 formed adjacent to the connecting member 32. Thus, the receiving hole 331 of the driving head 33 is rorarably engaged with the head portion 321 of the connecting member 32. Moreover, the driving head 33 includes a hexagonal driving hole 332 formed at an end thereof opposite to the connecting member 32 and adapted to engage with the fastener 91.

The heating unit 40 is received in the receiving slot 21 of the handle 20 and includes a circuit board 41 and a heater 42 electrically connected with each other. The circuit board 41 includes a switch 411 for controlling electricity to the heater 42 of the heating unit 40, and the switch 411 is exposed out of an outer surface of the handle 20. The heater 42 connects and contacts with the assembling portion 311 of the driving unit 30. The heater 42 is adapted for producing and conducting heat to the driving unit 30.

A user can assembly batteries 90 into the storage slot 23 of the handle 20 to cause the batteries 90 electrically connected with the circuit board 41. Thus, the user can use the hexagonal driving hole 332 of the driving head 33 to engage with the fastener 91. At this point, the user is able to open switch 411 to start the heater 42 generating and conducting heat to the driving unit 30. The fastener 91 held by the threadlocker 92 is heated up by the warmed driving unit 30 to cause the threadlocker 92 to be melted. Therefore, the fastener 91 can be simultaneously heated and rotated by the driving unit 30.

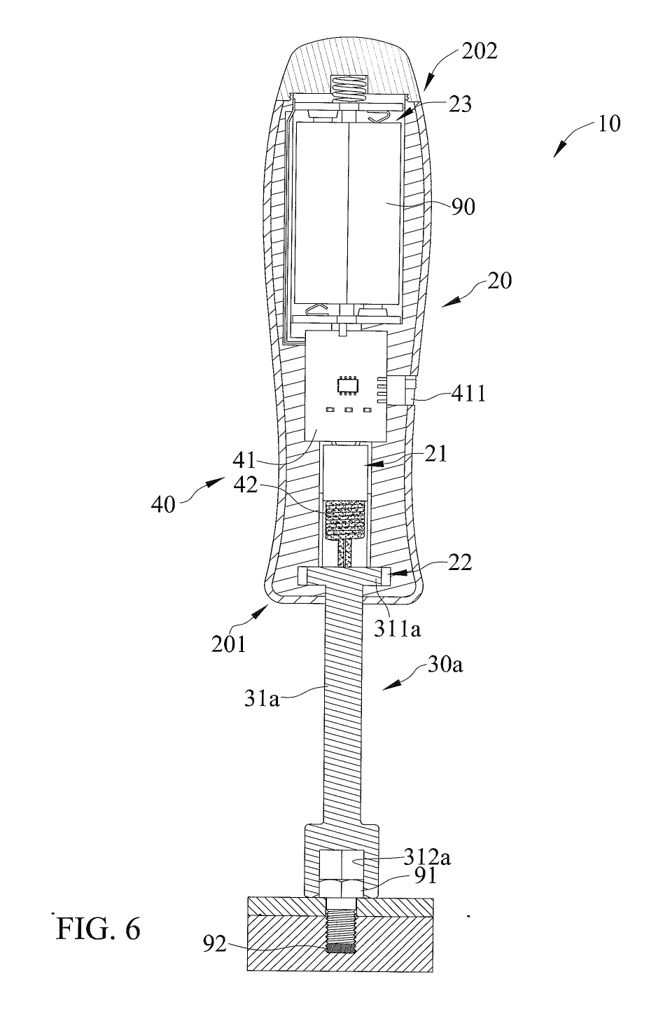

FIG. 6 shows a fastener driving tool 10a of a second embodiment according to the present invention. The second embodiment is substantially the same as the first embodiment except that the rod member 31a of the driving unit 30a includes a hexagonal driving hole 312a formed as one piece at an end thereof opposite to the assembling portion 311a and adapted to rotate the fastener 91.

In view of the foregoing, the fastener driving tool 10 and 10a according to the present invention generates heat by the heating unit 40 and then conducts heat to the driving unit 30 to heat up the fastener 91 held by the threadlocker 92 without a heat gun or a propane torch. Thus, the threadlocker 92 is melted so that the fastener 91 can be simultaneously rotated by the driving unit 30.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A fastener driving tool comprising:
a handle including an assembling end and a gripping end opposite to the assembling end, with a receiving slot arranged in the handle and disposed between the assembling end and the gripping end;
a driving unit adapted for driving a fastener and including a connecting end and a driving end opposite to the connecting end, with the connecting end of the driving unit connected to the assembling end of the handle, with the driving end of the driving unit extending opposite to the gripping end of the handle; and
a heating unit received in the receiving slot of the handle, with the heating unit including a circuit board and a heater, with the circuit board electrically connected with the heater, with the heater connecting and contacting with the driving unit, with the heater adapted for producing and conducting heat to the driving unit.

2. The fastener driving tool as claimed in claim 1, wherein the handle includes an assembling slot located at the assembling end, with the assembling slot disposed at a side of the receiving slot adjacent to the assembling end, with the assembling slot connected and in communication with the receiving slot, with the driving unit including a rod member provided with an assembling portion at an end thereof adjacent to the connecting end, with the assembling portion engaged into the assembling slot, with the heater connecting and contacting with the assembling portion of the rod member.

3. The fastener driving tool as claimed in claim 2, wherein the driving unit includes a connecting member and a driving head, with the connecting member connected to an end of the rod member opposite to the handle, with the driving head rorarably connected to an end of the connecting member opposite to the rod member.

4. The fastener driving tool as claimed in claim 3, wherein the end of the connecting member opposite to the rod member provided with a spherical head portion, with the head portion having a hexagonal cross-section along the radial direction of the driving unit, with the driving head including a hexagonal receiving hole formed adjacent to the connecting member, with the receiving hole of the driving head rorarably engaged with the head portion of the connecting member.

5. The fastener driving tool as claimed in claim 4, wherein the driving head includes a hexagonal driving hole formed at an end thereof opposite to the connecting member.

6. The fastener driving tool as claimed in claim 2, wherein the rod member of the driving unit includes a hexagonal driving hole formed at an end thereof opposite to the assembling portion.

7. The fastener driving tool as claimed in claim 2, wherein the handle includes a storage slot located in the gripping end, with the storage slot connected and in communication with the receiving slot and adapted to receive batteries to provide electricity to the heating unit.

8. The fastener driving tool as claimed in claim 2, wherein the assembling slot has a non-circular cross-section along a radial direction of the handle, wherein the assembling portion having a non-circular cross-section along a radial direction of the driving unit.

9. The fastener driving tool as claimed in claim 2, wherein the circuit board includes a switch for controlling electricity to the heater of the heating unit, with the switch exposed out of an outer surface of the handle.

10. The fastener driving tool as claimed in claim 3, wherein the connecting member is threadly connected to the end of the rod member opposite to the handle.
